(19) United States
(12) Patent Application Publication
(10) Pub. No.: US 2007/0217964 A1
(43) Pub. Date: Sep. 20, 2007

(54) Microreactor with auxiliary fluid motion control

(76) Inventors: Timothy J. Johnson, Andover, MA (US); Bernardo Aumond, Somerville, MA (US)

Correspondence Address: WOLF GREENFIELD & SACKS, P.C., 600 ATLANTIC AVENUE, BOSTON, MA, 02210-2206, US

(21) Appl. No.: 11/707,247

(22) Filed: Feb. 15, 2007

Related U.S. Application Data
(60) Provisional application No. 60/774,409, filed on Feb. 17, 2006.

(51) Int. Cl. B01J 19/00

(52) U.S. Cl. 422/130

(57) ABSTRACT

An apparatus for performing a biological or biochemical reaction that, in certain embodiments, has the ability to generate flow in a reaction site container by applying a force to a liquid medium that is outside of the reaction site container. In some embodiments, a flow generating component such as a gas bubble moves within a container and forces an agitating fluid to move through a reaction site container. In some embodiments, the movement of the agitating fluid applies shear stress to cells that are maintained within the reaction site container.

### RELATED APPLICATION

This application claims the benefit under 35 U.S.C. § 119(e) to U.S. Provisional Application Ser. No. 60/774,409, entitled “Microreactor with Auxiliary Fluid Motion Control”, filed on Feb. 17, 2006, which is hereby incorporated by reference in its entirety.

### RELATED ART

1. Field of the Invention

The present specification discloses the control of fluid motion within a reaction system, and in certain embodiments the control of fluid motion within at least two containers to affect the behavior of biological cells.

2. Description of Related Art

Cells are cultured for a variety of reasons. Increasingly, cells are cultured for proteins or other valuable materials they produce. Typically, cells require specific conditions be maintained for viability and/or optimal growth and/or productivity, maintenance of such conditions as with a controlled environment can be necessary or advantageous for many cell cultures. The presence of nutrients, metabolic gases such as oxygen and/or carbon dioxide, proper levels of humidity, as well as control of other factors such as temperature, may affect cell growth and/or cell behavior. Cells require time to grow, during which favorable conditions should be maintained. In some cases, such as with particular bacterial cells, a successful cell culture may be performed in as little as 24 hours. In other cases, such as with particular mammalian cells, a successful culture may require about 30 days or more.

Typically, cell cultures are performed in media suitable for cell growth and containing necessary nutrients. The cells are generally cultured in a location, such as an incubator, where the environmental conditions can be controlled. Incubators traditionally may range in size from small incubators (e.g., about 1 cubic foot or less) for a few cultures and/or small culture volumes up to an entire room or rooms in which the desired environmental conditions can be carefully maintained.

More generally, a wide variety of reaction systems are known for the production of products of chemical reactions, biochemical reactions, and/or biological systems. Chemical plants involving catalysis, biochemical fermenters, pharmaceutical production plants, and a host of other systems are well-known. Biochemical processing may involve the use of a live microorganism (e.g. cells) to produce a substance of interest.

As described in U.S. Patent Application Publication No. 2004/0121454, published on Jun. 24, 2004, entitled “Microreactor,” incorporated herein by reference, cells have also been cultured on a very small scale (i.e., on the order of a few milliliters of culture volume or less), so that, among other things, many cultures can be performed in parallel.

While important and valuable advances have been made in the field of cell culture and other fields, improvements would be valuable.

### SUMMARY

The present specification discloses chemical, biological, and/or biochemical reactor chips and/or reaction apparatuses and associated systems such as microreactor systems. The subject matter of this invention involves, in some cases, interrelated products, alternative solutions to a particular problem, and/or a plurality of different uses of one or more systems and/or articles.

According to one embodiment of the invention, a microreactor device includes a first container, substantially circular in cross-section, comprising a biological or biochemical reactor including a reaction site constructed and arranged to facilitate cell cultivation. The device also includes a second container arranged as a ring around the first container, and a first channel fluidly connecting the first container with the second container. A filter constructed and arranged to prevent cells from exiting the first container is also included in the device. A second channel fluidly connects the second container with the first container. The second container contains an agitating fluid and a flow generating component that is movable around the ring and within the agitating fluid such that continuous movement of the component in one direction around the ring creates fluid flow from the second container into the first container through the second channel for generation of agitation in the first container. The fluid flows from the first container into the second container through the first channel so as to form a fluidic circuit.

According to another embodiment of the invention, a microreactor device includes a first container having a biological or biochemical reactor including a reaction site constructed and arranged to facilitate cell cultivation, a second container having two ends, and a first microfluidic channel fluidly connecting the first container and the second container. The device further includes a second microfluidic channel fluidly connecting the second container with the first container to form a fluidic circuit. The second container contains an agitating fluid and a flow generating component that is freely suspendable in the second container within the agitating fluid, and the component is movable in the agitating fluid such that movement of the component in a general direction from one end toward the other end creates fluid flow within the first container for generation of agitation in the first container.

According to a further embodiment of the invention, a microreactor device includes a first container having a volume of less than about 2 milliliters, comprising a biological or biochemical reactor including a reaction site constructed and arranged to facilitate cell cultivation, a second container, and a first microfluidic channel fluidly connecting the first container and the second container. The second container contains an agitating fluid and a flow generating component in the second container within the agitating fluid. The flow generating component is movable in the agitating fluid to create fluid flow within the channel connecting the first container with the second container for generation of agitation in the first container.

According to yet another embodiment of the invention, a microreactor device includes a first container having a biological or biochemical reactor including a reaction site constructed and arranged to facilitate cell cultivation, a second container, and a first microfluidic channel fluidly connecting the first container and the second container. The second container contains an agitating fluid and a flow generating component freely suspendable in the second container within the agitating fluid, and the flow generating component is movable in the agitating fluid to create fluid flow within the first channel connecting the first container with the second container for generation of agitation in the first container.

In a further embodiment of the invention, a microreactor device includes a first container having a volume of less than about 2 milliliters and having a biological or biochemical reactor including a reaction site constructed and arranged to facilitate cell cultivation, and a fluidic circuit including the first container. The fluidic circuit includes a fluid agitation device which is external to the first container and constructed and arranged to agitate fluid in the first container.

According to another embodiment of the invention, a method for creating fluid flow in a microreactor device is provided. The microreactor device has a biological or biochemical reactor including a reaction site container constructed and arranged to facilitate cell cultivation and having a volume of less than about 2 milliliters. The microreactor device further includes a second container containing an agitating fluid and a flow generating component in the second container within the agitating fluid, the flow generating component being movable in the agitating fluid. The method includes moving the flow generating component in the second container to continuously flow the agitating fluid from the second container into the reaction site container at a substantially uniform flow rate from a first direction for at least five minutes.

In a further embodiment of the invention, a method for creating fluid flow in a microreactor device is provided. The microreactor device has a first container having a volume of less than about 2 milliliters and including a biological or biochemical reactor which has a reaction site constructed and arranged to facilitate cell cultivation. The method includes flowing an agitating fluid from a second container into the first container in a repetitive pulsatory manner for at least five minutes.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a chip including two reactors that can be used in accordance with one embodiment of the invention;

FIGS. 2a and 2b illustrate a reactor in two different orientations;

FIG. 3 is a cross-sectional side view of one embodiment of a two chamber reactor;

FIG. 4 shows a reaction site container including longitudinal channels according to one embodiment of the invention;

FIG. 5a shows a plan view of a reaction site container including orthogonal channels according to one embodiment of the invention;

FIG. 5b shows a cross-sectional view taken along line Vb-Vb of the reaction container of FIG. 5a;

FIG. 6 shows one illustrative embodiment of a rotating apparatus and control system that can be used with reactors, according to one embodiment of the invention;

FIG. 7a shows a plan view of a two chamber apparatus including a circumferential ring, according to another illustrative embodiment of the invention;

FIG. 7b shows a cross-sectional side view take along line VIIb-VIIb of FIG. 7; and

FIG. 7c shows a cross-sectional plan view taken along line VIIc-VIIc of FIG. 7b.

### DETAILED DESCRIPTION

The present specification discloses chemical, biological, and/or biochemical reactor chips and/or reaction systems such as microreactor systems, as well as systems and methods for using such devices. In certain embodiments of the invention, a reaction system includes at least two containers with which fluid motion and the application of shear stress to cells can be controlled.

In certain embodiments of the invention, a chip, a reactor, or a reaction system containing a liquid sample may be configured for reproducibly controlling and/or creating shear stress within a reaction site container, such as a cell culture chamber, for example in order to subject cells to particular shear stress. Shear stress can have a dramatic effect on the behavior of many types of biological cells by altering, for example, one or more of protein production, gene expression, cell morphology, or likelihood of cell death.

The shear stress may be created by moving a liquid medium within a reaction site container to create shear forces. The component for providing the force to move the liquid medium may be a substance which is immiscible within a liquid medium of a liquid sample that includes cells. A gas bubble, a solid bead (e.g. a glass or plastic bead), a magnetically-activated element (e.g. a magnetic bead), and/or a liquid bolus are examples of an immiscible substances that may be used as a flow generating component.

Certain chemical and pharmaceutical bioreactors, including large scale bioreactors, expose biological cells to hydrodynamic shear stress via mixing impellers and/or gas sparging, and/or various other means of pumping and/or mixing. Because of the various effects of shear stress on biological cells in these bioreactors, the successful operation of a bioreactor may depend on the creation of an appropriate amount of hydrodynamic shear. Data obtained from microreactor systems described herein may be used to design, operate or alter larger scale bioreactors, particularly with regard to shear stress generation. In certain embodiments, data obtained from or known regarding the shear exposure patterns of cells in larger scale reactors can be simulated in a microreactor system provided by the invention in order to test and/or optimize the effects of other changes in operation and/or design of the larger scale reactor systems under more realistic shear exposure conditions. Additionally, the ability to provide selected hydrodynamic shear exposure to cells and/or to control hydrodynamic shear exposure of cells is becoming increasingly important in the techniques involving tissue engineering and extracorpeal organ-assist devices.

In typical conventional small scale cell culture systems such as, for example, well plates and multiple shake flasks, creating similar levels of shear stress at particular locations in multiple vessels is difficult to control. For example, placing a well plate on a conventional mixing/shaking device puts wells at a different positions and/or orientations relative to the shaker mechanism. Liquid in one well of the well plate may tend to move in a much different manner than another, thus making it difficult to generate similar shear forces within multiple wells.

In certain embodiments of the present invention, multiple sample containers are positioned and oriented similarly on the same rotation apparatus. With such a configuration, the effects of varying certain parameters at a controlled shear stress level may be tested in parallel.

In addition, certain cell culture systems capable of parallel processing and/or high-throughput such as, for example, systems including multiple well plates or shake flasks, operate in a manner such that changing parameters which affect the shear stress (for example by changing the rate of movement or shaking) can substantially change the amount of surface area at the interface between the liquid sample and gas, thereby affecting the gas exchange rate.

In certain embodiments of the present invention, shear stress may be controlled substantially independently of the gas exchange rate into or out of the liquid sample, such that creating changes in the level and/or pattern of shear stress within the liquid sample does not significantly affect the amount of surface area at the interface between the liquid sample and gas, and, therefore, does not typically substantially affect the rate of gas exchange between the liquid sample and the exterior of a reactor that contains the liquid sample.

Such embodiments may include a flow generating component within a reactor, and also may include a control system, such as a computer-implemented process control system, in operative association with the reactor and configured for moving and/or controlling the movement of the flow generating component via, for example, the application of external force(s) such as gravitational, centrifugal, mechanical, pneumatic, hydraulic, magnetic, and/or electrical forces.

In typical conventional systems that can allow for some control of shear forces, such as perfusion systems and rotating drum systems, relatively large volumes of liquid sample, for example in excess of 5 milliliters, may be required for operation. Additionally, in many such systems, for each liquid sample, an independent flow generating component and controller are required. For example, in a perfusion system, each perfused vessel often may need a separate pump and/or controller, and, in a rotating drum system, each rotating drum assembly or small group of rotating drum assemblies may often require a separate motor and/or controller.

Certain embodiments of the present invention involve methods and systems which allow for the controllable creation of shear stress in reaction site containers on chips, without, in many cases, the use of pumps external to the chips. In some such embodiments, an immiscible substance, such as a gas bubble, an immiscible liquid, or a solid, is used within a second container, distinct from but fluidically connected to the reaction site container, as a flow generating component such that movement of the immiscible substance generates a flow in the reaction site container, and thus generates shear stress within the reaction site container. It may desirable, in some instances, to have the flow generating component be disposed external to the reaction site container, particularly when attached cells are present within the reaction site container.

In some embodiments, the gas bubble (or other immiscible substance), which may be disposed in a second container and is moved within the container by reorienting the container. A density difference between the immiscible substance and the liquid medium in which the immiscible substance is disposed results in the movement of the immiscible substance via gravitational and/or centrifugal forces. Of course any combination of the above immiscible substances also may be used within a container. For purposes herein, neither the liquid sample itself nor any portion thereof is considered to be a flow generating component. Also for purposes herein, the interior walls of a container are not considered to be a flow generating component.

As mentioned above, in some embodiments, an immiscible substance may have a density that is sufficiently different from the average density of the liquid sample or carrier liquid such that changing the orientation of the container moves the immiscible substance relative to the container. This density difference may be, for example, at least 1% different than the average density of the liquid sample or carrier liquid, at least 2% different, at least 5%, at least 7%, or at least 10% different. The change in orientation causes the immiscible substance of different density to rise or sink within its container depending on whether the immiscible substance has a higher or lower density than the liquid sample.

As used herein, “immiscible” defines a relationship between two substances that are largely immiscible with respect to each other, but can be partially miscible. “Immiscible” substances, even if somewhat miscible with each other, will largely remain separate from each other in an observable division. For example, air and water meet this definition, in that a container of the invention containing primarily water or an aqueous solution and some air will largely phase-separate into an aqueous portion and a gas bubble or gas region, even though air is slightly soluble in water and water vapor may be present in the air. Other examples of immiscible substances, albeit those that may be somewhat miscible with each other, include oil and water, a polymeric bead and water, a glass bead and water, and the like.

The introduction of an immiscible substance within a liquid sample in a container may include the addition or creation of a gas bubble. The gas bubble may be introduced by partially filling the container with a liquid sample and leaving a portion of the volume as the originally present gas (typically air). In other embodiments, evaporation, cellular respiration, or the introduction of gas after filling the container may form a gas bubble.

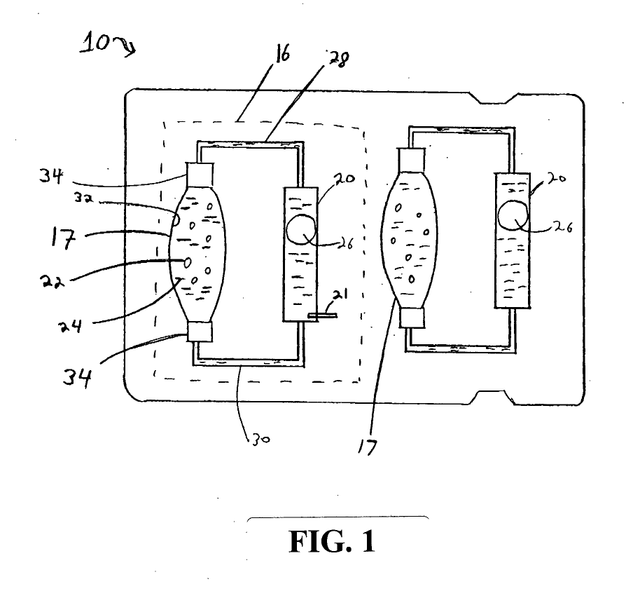

FIG. 1 illustrates one embodiment of a chip 10 which includes two reactors 16. Each reactor 16 has a reaction site container 17 and a second container 20. Cells 22 are shown suspended in a liquid medium 24. A flow generating component, in this embodiment a gas bubble 26, is disposed within second container 20 such that it is freely movable within the container.

Two channels 28, 30 fluidically connect second container 20 to reaction site container 17. In some embodiments, such as the one illustrated in FIG. 1, each of channels 28, 30 acts as both an inlet channel and an outlet channel to reaction site container 17 depending on the orientation of chip 10. For instance, in the orientation illustrated in FIG. 1, gas bubble 26 will rise within second container 20 and push liquid medium 24 through channel 28 into reaction site container 17 such that channel 28 acts as an inlet channel to reaction site container 17. As this flow enters reaction site container 17 via channel 28, liquid medium 24 exits reaction site container through channel 30. In this manner, gas bubble 26 generates a flow within reaction site container, and this flow may apply shear stress to cells 22 suspended in liquid medium 24, or to cells attached to interior walls 32 of reaction site container 17, or to cells present on filters 34 at either end of reaction site container 17.

Filters 34 may be used at one or more of the channels that are connected to a reaction site container. Filters 34 restrict movement of cells 22 outside of reaction site container 17. In some embodiments, no filters are used and suspended cells 22 are permitted to travel throughout reactor 16, including within second container 20.

Sensors and/or areas that allow for optical or other measurement of conditions in reactor 16 may be positioned throughout the reactor. For example, sensors may be included for measuring pH, glucose concentration, or temperature and/or other environmental factors present in the liquid medium in second container 20. In some cases, the sensors may be positioned within reaction site container 17, second container 20 or both containers. A sensor 21 for measuring glucose concentration in second container 20 is shown in FIG. 1. Other examples of environmental factors for which sensors may be provided to sense include: CO₂ concentration, glutamine concentration, pyruvate concentration, apatite concentration, serum concentration, a concentration of a vitamin, a concentration of an amino acid, a concentration of a hormone, a concentration of a dissolved gas, molarity, osmolarity, glucose concentration, glutamine concentration, pyruvate concentration, apatite concentration, color, turbidity, viscosity, a concentration of an amino acid, a concentration of a vitamin, a concentration of a hormone, serum concentration, a concentration of an ion, shear rate, and degree of agitation.

In some embodiments, nutrients for cells may be held in second container 20 in a time-release arrangement such that movement of liquid medium from second container 20 to reaction site container 17 carries nutrients to the cells in reaction site container 17.

As should be evident to one of skill in the art, more than one reaction site container 17 may be fluidically connected to a second container that generates flow. In some embodiments, multiple flow generation containers may be fluidically connected to one or more reaction site containers 17.

Chip 10 may be manufactured in any suitable manner. A description of examples of chip manufacturing methods can be found in U.S. Patent Application Publication No. US2005/0032204 A1, which is hereby incorporated by reference in its entirety. Characteristics of the container, such as its size and/or geometry, can be varied to affect the generation and/or distribution of shear according to some embodiments of the invention.

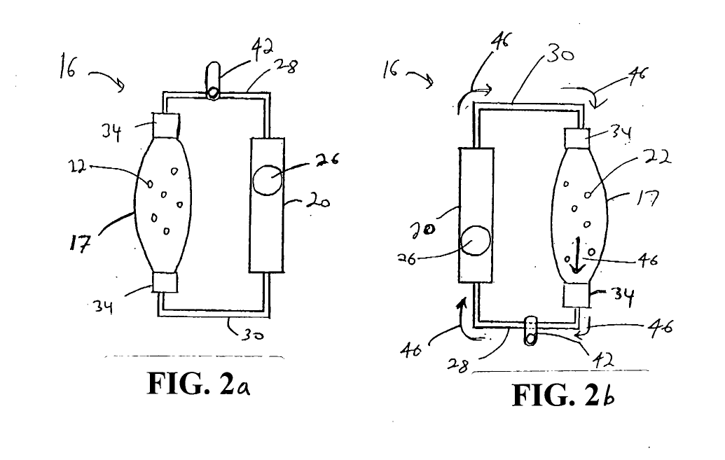

A unidirectional embodiment of a reactor 16 is illustrated in FIGS. 2a and 2b. In this embodiment, a check valve 42 is incorporated within channel 28 such that flow from second container 20 to reaction site container 17 occurs only in certain orientations. For example, when in the orientation shown in FIG. 2a, check valve 42 prevents flow of liquid medium through channel 28. As such, the flow generated by the rising of gas bubble 26 through second container 20 is mostly annular flow around the outside of gas bubble 26. This movement results in mixing within second container 20, but limited or non-existent flow is present throughout the rest of reactor 16.

Reorienting reactor 16 to the orientation shown in FIG. 2b results in check valve 42 permitting flow through channel 28. As gas bubble 26 rises through second container 20 toward outlet channel 30, liquid medium flows in the direction of arrows 46. When reactor 16 is oriented back to the orientation of FIG. 2a, gas bubble 26 moves toward channel 28, but does not generate flow in reaction site container 17. In this manner, unidirectional flow can be generated in reaction site container 17 simply by repeatedly changing the orientation of reactor 16. Of course a flow generation component that has a higher density than the liquid medium in which it is disposed will sink upon each reorientation, and the liquid medium will flow in a direction opposite to the direction of arrows 46 when reactor 16 is oriented as in FIG. 2B.

Filters 34 may be used at one or both ends of reaction site container 17 to prevent cells from exiting. In some embodiments that are constructed and arranged for unidirectional flow, the filter located at the end that is connected to channel 30 is not used because flow out of the reaction site container in that direction is limited. In other embodiments, filters may be placed within one or more channels instead of at the ends of reaction site container 17.

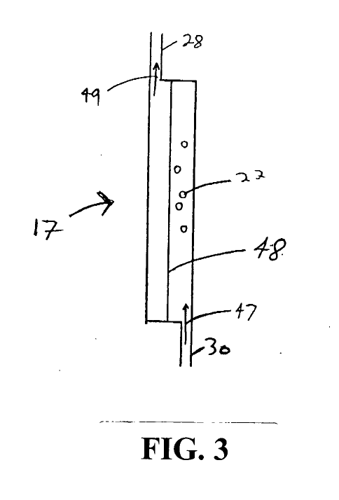

FIG. 3 illustrates a cross-sectional side view of one embodiment of reaction site container 17 which includes a membrane 48 that prevents suspended cells 22 from moving outside of reaction site container 17. In the embodiments described above with reference to FIGS. 1 and 2a-2b, filters 34 were employed to prevent suspended cells from exiting the reaction site container. In the reaction site container 17 illustrated in FIG. 3, membrane 48 is positioned within reaction site container 17 to span the entire container, thus providing a large surface area for allowing the flow of liquid medium while preventing passage of suspended cells 22 out of reaction site container 17. A liquid medium enters reaction site container 17 via inlet channel 30 in the direction of arrow 47, passes through membrane 48, and exits reaction site container 17 via outlet channel 28 in the direction of arrow 49. The existence of a larger surface area (relative to filters or membranes positioned at an outlet channel) may result in lower flow resistance and reduce the possibility of the cells clogging the barrier.

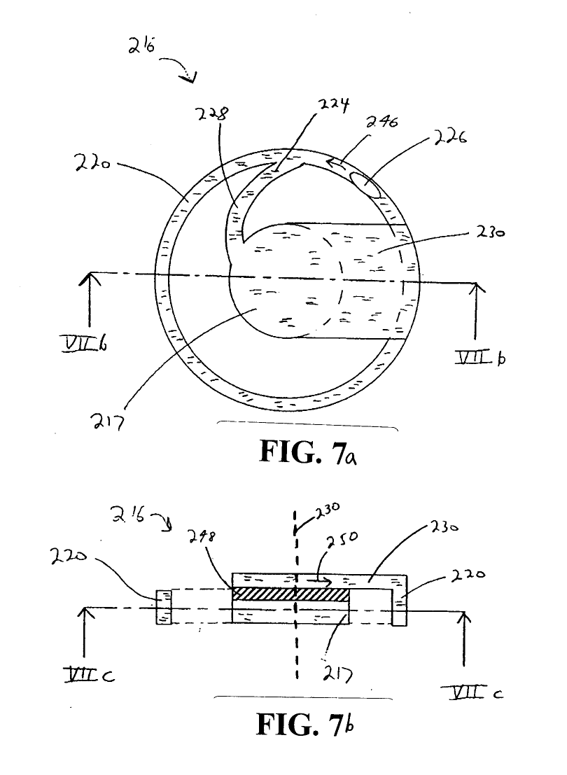

Containers used in accordance with the invention may have small volumes and/or numerous containers may be provided on a single chip such that numerous containers may be efficiently reoriented and/or controlled. In some cases, shear stress may be reproducibly created in multiple containers, and in certain embodiments, a large number of containers, using a single actuator for creating movement of the flow generating components. For example, a plurality of chips, each including multiple containers including flow generating components, in certain embodiments is attached to a single device configured to rotate the plurality of chips (e.g., see FIG. 6). By facilitating the parallel testing of large numbers of liquid samples, the effects of shear stress on many different cells under numerous different shear exposure conditions may be accomplished efficiently.

Chip or reaction systems used in accordance with certain embodiments of the invention include reaction site containers that can be very small, for example, having a volume of less than about 5 milliliters, less than about 1.2 milliliters, less than about 1 milliliter, or smaller—in some embodiments as small as 0.01 milliliters. In some embodiments, the reaction site includes compartments or containers that include a surface that is formed with a membrane.

In some embodiments of the invention, a reactor, a container, and/or a reaction site within a chip may be constructed and arranged to maintain an environment that promotes the growth of one or more types of living cells, for example, simultaneously. In some cases, the reaction site may be provided with fluid flow, oxygen, nutrient distribution, etc., conditions that are similar to those found in living tissue, for example, tissue from which the cells originate. Thus, the chip may be able to provide conditions that are closer to in vivo conditions than those provided by batch culture systems. In embodiments where one or more cells are used in the reaction site, the cells may be of essentially any cell type, for instance a prokaryotic cell or a eukaryotic cell. The precise environmental conditions necessary in the reaction site for a specific cell type or types are known or may be determined by those of ordinary skill in the art using routine experimentation.

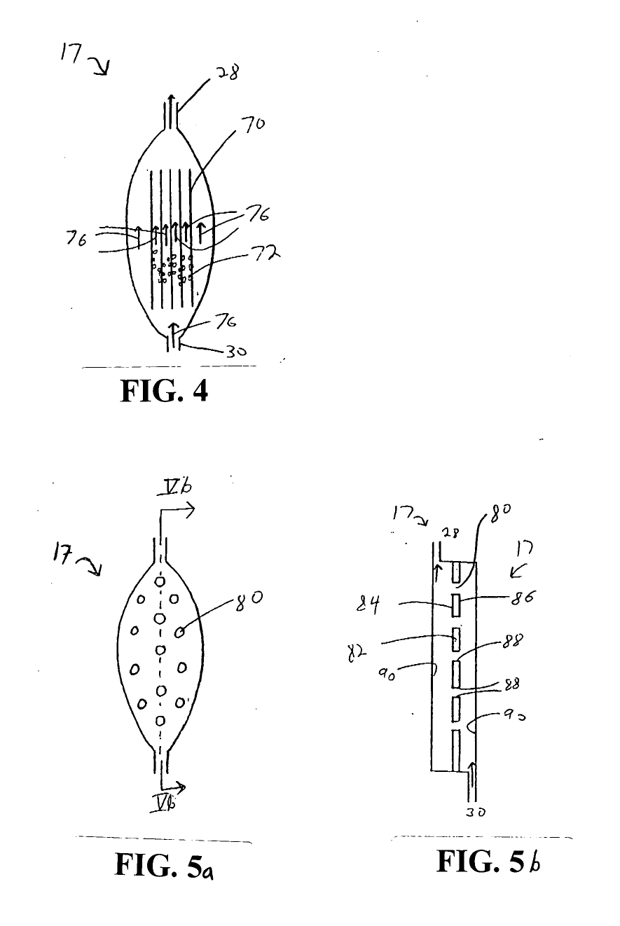

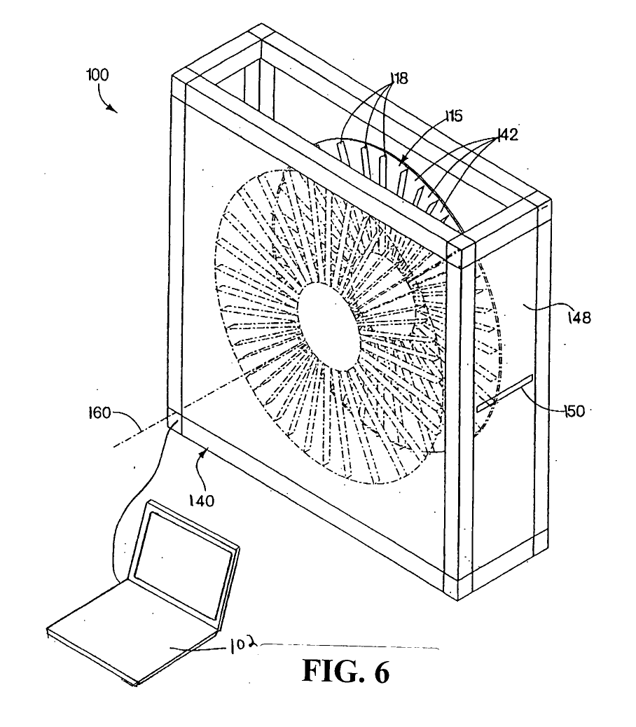

FIGS. 4 and 5a-5b illustrate two embodiments of reaction site containers 17 that simulate conditions found in lumen surfaces of the human body. In FIG. 4, a series of channels 70 are positioned longitudinally within reaction site container 17. Attached cells 72 are exposed to shear stress by flowing liquid medium which travels in the direction of arrows 76. The reaction site container illustrated in this embodiment may be employed with an arrangement as shown in FIG. 1, thereby allowing flow in alternating directions, or may be employed with an arrangement as illustrated in FIGS. 2a and 2b, thereby having unidirectional flow. In either case, flow may be introduced into the reaction site container of FIG. 4 in a pulsatory manner.

FIGS. 5a and 5b illustrate a reaction site container 17 which includes orthogonal channels 80 to simulate conditions in which cells are exposed to shear in a capillary or vein or artery in the human body. In this embodiment, reaction site container 17 is divided by a septum, e.g. a polystyrene sheet 82 having a thickness selected from a range of 100 microns to one millimeter. Of course, other suitable materials and/or thicknesses may be used, and the particular septum is not intended to be limiting. The septum includes holes, such as round holes, that form channels 80, each channel having a diameter of between 100 microns and one millimeter in some embodiments. Flat surfaces 84 and 86 and walls 90 of reaction site container 17 are treated such that cells are inhibited from attaching to these surfaces. One method of treating flat surfaces 84, 86 to prevent cell attachment is to treat the surfaces such that protein is prevented from denaturing on the surface.

Inner walls 88 of channels 80 are made to be non-resistant to cell attachment and therefore cells within reaction site container 17 attach to inner walls 88. Within the channels 80, each cell is exposed to shear as liquid medium is flowed through the channel. As with FIG. 4, reaction site container 17 may be employed with any of the flow generating arrangements described herein, or any other suitable arrangement, for providing a flow through channels 80.

In some embodiments, hepatocyte cells may be used in reaction site container 17 and channels 80 may be sized to simulate capillaries or veins found in the liver. When used with chips which are capable of maintaining living cells, the hepatocyte cells may be exposed to shear for a biologically significant length of time. For example, in some embodiments, hepatocyte cells may be maintained in reaction site container 17 for one day, one week, or longer. Shear stress may be applied to the cells continuously, or in a pulsatory manner during this cell maintenance period.

As described above, one method, according to certain embodiments of the invention, of moving a flow generating component involves using a rotating apparatus to change the orientation of a reactor such that the flow generating component moves within the reactor. For example, a flow generating component such as a gas bubble may be contained within a container and inverting the container may cause the bubble to move from one end to the other end due to buoyancy forces.

To move multiple chips or reaction site containers that contain liquid samples so as to create shear stress, a single apparatus may be used in certain embodiments of the invention. FIG. 6 shows an apparatus 100 for manipulating a chemical, biological, or biochemical sample in accordance with a variety of embodiments of the present invention. Apparatus 100, and other arrangements shown in the figures, are intended to be exemplary only. Other arrangements are possible and are embraced by the present invention. Apparatus 100 includes a housing 140 of generally rectangular solid shape. In the embodiment illustrated, housing 140 of apparatus 100 includes two, generally square, opposed major surfaces joined by four edges of rectangular shape. Housing 410 may be configured as, for example, an incubator. In some cases, housing 140 may be sufficiently enclosed so as to keep a device 115 clean, free of dust particles, within a laminar flow field, sterile, etc., depending on the application.

In certain embodiments, a control system 102 is used to operate apparatus 100 or other device(s) involved in the creation of shear stress. Control system 102 may be configured to control one or more operating parameters associated with apparatus 100, the flow generating component, the reaction container, the chip, and/or any other components associated with an overall shear-generation system. For example, control system 102 may control the rotation rate (steady or varying) of a component of apparatus 100. Control system 102 may be attached to devices other than a rotating apparatus, for example, control system 102 may be attached to systems that can add or remove gas from the reactor container to alter the size of a gas bubble that is acting as the flow generating component. In certain embodiments, control system 102 may have the ability to alter the orientation of the chip to the rotating apparatus.

Apparatus 100 may be rotated at any suitable rate. In some embodiments, rotation rates of 2 rpm, 4 rpm, 8 rpm, or 16 rpm may be used, for example. In other embodiments, much higher or much lower rotation rates would be suitable depending on the species present in the liquid sample, the type and density of flow generating component present, the level of shear stress desired, the size of the container and the rotation apparatus, and other factors. In certain embodiments, discontinuous, e.g., pulsed, rotation rates may be used. For example, apparatus 100 may be rotated at a slower rate for a length of time and then briefly rotated at a faster rate. The faster rotation rate may help to dislodge components from interior surfaces of the container and/or facilitate a more even distribution of components throughout the liquid sample. In other embodiments, the rotation of apparatus 100 may stop altogether for periods of time, for example to perform measurements of the liquid samples or components therein.

Control system 102 may be programmed to receive feedback of various data during control operations to allow for adjustment and/or optimization of various operating parameters during operation. In certain embodiments, control system 102 may be configured to operate in conjunction with simulation software, e.g. a computational fluid dynamics software product such as FLUENT® (FLUENT USA, Lebanon N.H.), to use feedback data to develop parameter values for future operations and/or control present operating parameters.

Control system 102 may comprise a computer-implemented system. The computer implemented control system may include several known components and circuitry, including a processing unit (i.e., processor), a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as known to those of ordinary skill in the art. Further, the computer system may be a multi-processor computer system or may include multiple computers connected over a computer network.

Mounted within housing 140, on an axis 160 passing through the two, opposed major surfaces of the housing, is a device 115 for securing a plurality of individual substrates such as chips (chips not shown in FIG. 6) which may be constructed to contain a sample. Device 115 takes the form of a rotatable wheel with a plurality of radially outwardly extending members 18 which define, therebetween, a plurality of slots 142 within which one or more chips can be positioned. Once the chips are secured within slots 142, device 115 can be rotated, manually or automatically, about axis 160, thereby periodically inverting the chips secured in slots 142. Of course, in some embodiments, axis 160 may pass through only one of the major surfaces of the housing.

Within one face 148 of housing 140, which defines one of the edges of the housing joining the opposed major surfaces, is access port 150 through which a chip (or other substrate) can be introduced into and removed from the interior of housing 140. Access port 150 may be positioned anywhere within housing 140 that allows suitable access of chips or other substrates to apparatus 100, for example, in a side of housing 140 or on one or more major surfaces of housing 140. For the insertion of a chip into device 115 to be secured within a slot 142 of device 115, device 115 is rotated so that a desired slot is aligned with access port 50, and a chip is then inserted through access port 150 to be secured by a slot 142 within a selection region. Device 115 can be rotated to any predetermined radial orientation for aligning a desired slot 142 with access port 150, so that one or more chips can be positioned within predetermined slots 142, and their location known so the chips can be removed from device 115 such that a particular slot securing a particular chip is aligned with access port 150 for removal from device 100. The chips (or other substrates) can be inserted into and removed from housing 140 via slot 150 by essentially any suitable technique including manual operation by hand, operation by an actuator, or robotic actuation, etc. Access port 150 may be an opening in wall 148 of the housing, optionally including a flap, door, or other member that allows access port 150 to be closed when not being used to introduce or remove a chip from the housing.

In certain embodiments, instead of, or in addition to, moving container 20 so as to move a flow generating component, e.g. by rotational inversion as discussed above, a magnetic, electrical, mechanical, pneumatic, hydraulic, and/or other force may be used. For example, a bead or beads that respond to magnetic and/or electric fields may be placed in container 20. A controlled application of a magnetic and/or electrical field may be used to move such bead(s) within container 20. Flow generating components that are moved by forces other than gravity/buoyancy can be the same density as the liquid within which they are contained. In some embodiments, a single controlled magnetic or electrical field may be used to move beads within numerous containers 20. Such embodiments may reduce the number of moving components of the overall system. Specifically, the ability to reduce or eliminate the movement of containers 20 while generating shear may allow for easier application of measurement techniques, such as optical measurement techniques, to the liquid samples.

While freely suspended flow generating components such as gas bubbles or beads described above may be used within a container, in some embodiments, flow generating components which are movably attached, either directly or indirectly, to a surface of the container, may be employed.

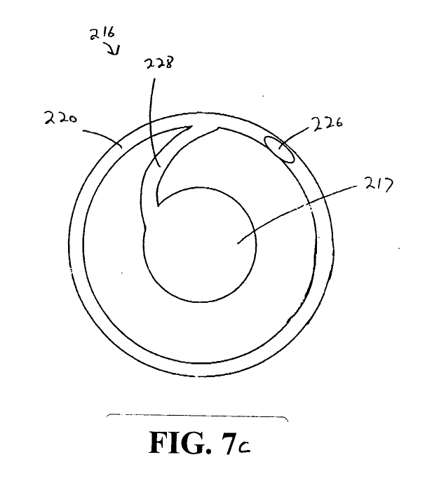

FIGS. 7a-7c illustrate a reactor 216 which includes a ring-shaped second container 220 through which a flow generating component such as a gas bubble 226 may travel continuously, thereby creating a continuous fluid flow of a liquid medium 224 in a reaction site container 217. To move the gas bubble through ring-shaped second container, reactor 216 is continuously reoriented so that gas bubble 226 continuously rises toward a higher point. The reorientation may comprise supporting reactor 216 substantially horizontally and wobbling the reactor about an axis such as axis 230 (see FIG. 7b). In other embodiments, the reorientation may comprise supporting the reactor 216 substantially vertically and rotating the reactor about axis 230.

Regardless of how movement of gas bubble 226 is achieved, as gas bubble 226 travels in the direction of arrow 246, some amount of liquid medium 224 is forced into channel 228 which is fluidically connected to reaction site container 217. Reaction site container 217 includes suspended cells and/or attached cells. As can be seen in FIG. 7b, a membrane 248 prevents the cells from exiting reaction site container 217 via outlet channel 230, but allows liquid medium to return to ring-shaped second container 220 via outlet channel 230. Liquid medium flows through outlet channel 230 in the direction of arrow 250 and reenters ring-shaped second container 220 at the top of second container 220.

Ring-shaped second container 220 need not encircle reaction site container 217 as shown in the illustrated embodiment. Reaction site container 217 may be disposed at a substantially different vertical height than ring-shaped second container 220. In other embodiments, inlet channel 228 and reaction site container 217 may be positioned outside of ring-shaped second container 217. Additionally, ring-shaped container 217 need not be circular or even arcuate. In some embodiments, a polygonal shape may be used. The particular configuration of the inlet and outlet channels shown in FIGS. 7a-7c are not required, and multiple inlet and/or outlet channels may be used. Multiple flow generating components may be used, including a combination of different types of flow generating components (e.g. a combination of a gas bubble and a glass bead). Various features of the reaction site containers described above with reference to FIGS. 4, 5a and 5b may be employed with the reactor arrangement shown in FIG. 7.

Definitions

A “chemical, biological, or biochemical reactor chip,” (also referred to, equivalently, simply as a “chip”) as used herein, is an integral article that includes one or more reactors. “Integral article” means a single piece of material, or assembly of components integrally connected with each other. As used herein, the term “integrally connected,” when referring to two or more objects, means objects that do not become separated from each other during the course of normal use, e.g., cannot be separated manually; separation requires at least the use of tools, and/or by causing damage to at least one of the components, for example, by breaking, peeling, etc. (separating components fastened together via adhesives, tools, etc.).

A chip can be connected to or inserted into a larger framework defining an overall reaction system, for example, a high-throughput system. The system can be defined primarily by other chips, chassis, cartridges, cassettes, and/or by a larger machine or set of conduits or channels, sources of reactants, cell types, and/or nutrients, inlets, outlets, sensors, actuators, and/or controllers. Typically, the chip can be a generally flat or planar article (i.e., having one dimension that is relatively small compared to the other dimensions); however, in some cases, the chip can be a non-planar article, for example, the chip may have a cubical shape, a curved surface, a solid or block shape, etc.

As used herein, a “reaction site” is defined as a site within a reactor that is constructed and arranged to produce a physical, chemical, biochemical, and/or biological reaction during use of the chip or reactor. More than one reaction site may be present within a reactor or a chip in some cases. The reaction may be, for example, a mixing or a separation process, a reaction between two or more chemicals, a light-activated or a light-inhibited reaction, a biological process, and the like. In certain embodiments, the reaction site may also include one or more cells and/or tissues.

The volume of the reaction site can be very small in certain embodiments and may have any convenient size. Specifically, the reaction site may have a volume of less than one liter, less than about 100 ml, less than about 10 ml, less than about 5 ml, less than about 3 ml, less than about 2 ml, less than about 1.2 ml, less than about 1 ml, less than about 500 microliters, less than about 300 microliters, less than about 200 microliters, less than about 100 microliters, less than about 50 microliters, less than about 30 microliters, less than about 20 microliters or less than about 10 microliters in various embodiments. The reaction site may also have a volume of less than about 5 microliters, or less than about 1 microliter in certain cases. In another set of embodiments, the reaction site may have a dimension that is 2 millimeters deep or less, 500 microns deep or less, 200 microns deep or less, or 100 microns deep or less.

“Elongate(d),” as used herein when referring to a chamber or substrate or container or predetermined reaction site of an article, refers to such chamber or substrate or container or predetermined reaction site having a perimetric shape, e.g., of an outer boundary or container, that is characterized by there being a first straight line segment, contained within the outer boundary/container, connecting two points on the outer boundary/container and passing through the geometric center of the chamber or substrate or container or predetermined reaction site, that is substantially longer than a second straight line segment, perpendicular to the first line segment, contained within the outer boundary/container, connecting two points on the outer boundary/container—other than the same two points connected by the first line segment—and passing through the geometric center of the chamber or substrate or container or predetermined reaction site. For example, if the article is a planar chip comprising a volumetric container defining a predetermined reaction site characterized by a thickness, measured in a direction perpendicular the plane of the chip and a length and width, measured in mutually perpendicular directions both parallel to the plane of the chip, the predetermined reaction site would be “elongate,” if the length substantially exceeded the width (e.g., as would be the case for a thin, rectangular or ellipsoidal, tear-shaped, etc., predetermined reaction site). A direction co-linear with the longest such straight line segment, contained within the outer boundary/container, connecting two points on the outer boundary/container and passing through the geometric center of the chamber or substrate or container or predetermined reaction site for an elongate chamber, substrate, container or predetermined reaction site is referred to herein as the “longitudinal direction” of the chamber or substrate or container or predetermined reaction site.

As used herein, a “membrane” is a thin sheet of material, typically having a shape such that one of the dimensions is substantially smaller than the other dimensions, that is permeable to at least one substance in an environment to which it is or can be exposed. In some cases, the membrane may be generally flexible or non-rigid. As an example, a membrane may be a rectangular or circular material with a length and width on the order of millimeters, centimeters, or more, and a thickness of less than a millimeter, and in some cases, less than 100 microns, less than 10 microns, or less than 1 micron or less. The membrane may define a portion of a reaction site and/or a reactor, or the membrane may be used to divide a reaction site into two or more portions, which may have volumes or dimensions which are substantially the same or different. Non-limiting examples of substances to which the membrane may be permeable to include water, O₂, CO₂, or the like. As an example, a membrane may have a permeability to water of less than about 1000 (g micrometer/m²·day), 900 (g micrometer/m²·day), 800 (g micrometer/m²·day), 600 (g micrometer/m²·day) or less; the actual permeability of water through the membrane may also be a function of the relative humidity in some cases. As another example, a membrane may have a permeability to oxygen of about 0.061 mol O₂/(day·m²·atm) or greater.

Some membranes may be semipermeable membranes, which those of ordinary skill in the art will recognize to be membranes permeable with respect to at least one species, but not readily permeable with respect to at least one other species. For example, a semipermeable membrane may allow oxygen to permeate across it, but not allow water vapor to do so, or may allow water vapor to permeate across it, but at a rate that is at least an order of magnitude less than that for oxygen. Or a semipermeable membrane may be selected to allow water to permeate across it, but not certain ions. For example, the membrane may be permeable to cations and substantially impermeable to anions, or permeable to anions and substantially impermeable to cations (e.g., cation exchange membranes and anion exchange membranes). As another example, the membrane may be substantially impermeable to molecules having a molecular weight greater than about 1 kilodalton, 10 kilodaltons, or 100 kilodaltons or more. In one embodiment, the membrane may be impermeable to cells, but be chosen to be permeable to varied selected substances; for example, the membrane may be permeable to nutrients, proteins and other molecules produced by the cells, waste products, or the like. In other cases, the membrane may be gas impermeable. Some membranes may be transparent to particular light (e.g. infrared, UV, or visible light; light of a wavelength with which a device utilizing the membrane interacts; visible light if not otherwise indicted). Where a membrane is substantially transparent, it absorbs no more than 50% of light, or in other embodiments no more than 25% or 10% of light, as described more fully herein. In some cases, a membrane may be both semipermeable and substantially transparent.

In some cases, the material of the membrane may include monomers or polymers, or a co-polymer, a polymer blend, a multi-layered structure comprising polymers in at least one layer, etc. Non-limiting examples of polymers that may be used within the membrane material include polyfluoroorganic materials such as polytetrafluoroethylenes (e.g., such as those marketed under the name TEFLON® by DuPont of Wilmington, Del., for example, TEFLON® AF) or certain amorphous fluoropolymers; polystyrenes; polypropylenes (“PP”); silicones such as polydimethylsiloxanes; polysulfones; polycarbonates; acrylics such as polymethyl acrylate and polymethyl methacrylate; polyethylenes such as high-density polyethylenes (“HDPE”), low-density polyethylenes (“LDPE”), linear low-density polyethylenes (“LLDPE”), ultra low-density polyethylenes (“ULDPE”) etc.; PET; polyvinylchloride (“PVC”) materials; nylons; a thermoplastic elastomer; poly(1-trimethlsilyl-1-propyne) (“PTMSP”); and the like. Another example is poly(4-methylpentene-1) or poly(4-methyl-1-pentene) or poly(4-methyl-2-pentyne) (“PMP”). Examples of PMPs include those marketed under the name TPX™ by Mitsui Plastics (White Plains, N.Y.). As still another example, membrane material may include poly(4-methylhexene-1), poly(4-methylheptene-1), poly(4-methyloctene-1), etc. In some cases, these materials may be copolymerized and/or in a polymer blend in association with the polymers as described above.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one act, the order of the acts of the method is not necessarily limited to the order in which the acts of the method are recited.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively.

What is claimed is:

1. A microreactor device, comprising:
a first container, substantially circular in cross-section, comprising a biological or biochemical reactor including a reaction site constructed and arranged to facilitate cell cultivation;
a second container arranged as a ring around the first container;
a first channel fluidly connecting the first container with the second container;
a filter constructed and arranged to prevent cells from exiting the first container; and
a second channel fluidly connecting the second container with the first container;
wherein the second container contains an agitating fluid and a flow generating component that is movable around the ring and within the agitating fluid such that continuous movement of the component in one direction around the ring creates fluid flow from the second container into the first container through the second channel for generation of agitation in the first container; and
wherein fluid flows from the first container into the second container through the first channel so as to form a fluidic circuit.

2. A microreactor device, comprising:
a first container comprising a biological or biochemical reactor including a reaction site constructed and arranged to facilitate cell cultivation;
a second container having two ends;
a first microfluidic channel fluidly connecting the first container and the second container; and
a second microfluidic channel fluidly connecting the second container with the first container to form a fluidic circuit; wherein
the second container contains an agitating fluid and a flow generating component that is freely suspendable in the second container within the agitating fluid, the component movable in the agitating fluid such that movement of the component in a general direction from one end toward the other end creates fluid flow within the first container for generation of agitation in the first container.

3. A microreactor device, comprising:
a first container having a volume of less than about 2 milliliters, comprising a biological or biochemical reactor including a reaction site constructed and arranged to facilitate cell cultivation;
a second container; and
a first microfluidic channel fluidly connecting the first container and the second container; wherein
the second container contains an agitating fluid and a flow generating component in the second container within the agitating fluid, the flow generating component movable in the agitating fluid to create fluid flow within the channel connecting the first container with the second container for generation of agitation in the first container.

4. A microreactor device as in claim 3, further comprising a second microfluidic channel connecting the second container and the first container to form a fluidic circuit.

5. A microreactor device as in claim 3, further comprising a filter that prevents cells from leaving the first container.

6. A microreactor device as in claim 3, further comprising a filter that prevents cells from entering the second container.

7. A microreactor device as in claim 3, further comprising a check valve that provides for unidirectional flow from the second chamber to the first chamber.

8. A microreactor device as in claim 3, wherein there is unidirectional flow within the first microfluidic channel.

9. A microreactor device as in claim 8, wherein the unidirectional flow is from the second chamber to the first chamber and is brought about without the use of a check valve.

10. A microreactor device as in claim 3, wherein the component is freely suspendable in the second container within the agitating fluid.

11. A microreactor device as in claim 3, wherein the first container has a volume of no greater than 1.2 milliliters.

12. A microreactor device, comprising:
a first container comprising a biological or biochemical reactor including a reaction site constructed and arranged to facilitate cell cultivation;
a second container; and
a first microfluidic channel fluidly connecting the first container and the second container; wherein
the second container contains an agitating fluid and a flow generating component freely suspendable in the second container within the agitating fluid, the flow generating component movable in the agitating fluid to create fluid flow within the first channel connecting the first container with the second container for generation of agitation in the first container.

13. A microreactor device as in claim 12, further comprising a second microfluidic channel connecting the second container and the first container to form a fluidic circuit.

14. A microreactor device as in claim 12, wherein the first container has a volume of less than about 2 milliliters.

15. A microreactor device as in claim 12, wherein the first container has a volume of no greater than 1.2 milliliters.

16. A microreactor device, comprising:
a first container having a volume of less than about 2 milliliters and comprising a biological or biochemical reactor including a reaction site constructed and arranged to facilitate cell cultivation; and
a fluidic circuit including the first container, the fluidic circuit including a fluid agitation device which is external to the first container and constructed and arranged to agitate fluid in the first container.

17. A microreactor device as in claim 16, wherein the agitation device is a second container that is fluidly connected to the first container.

18. A microreactor device as in claim 17, wherein the second container is fluidly connected to the first container with an inlet channel.

19. A microreactor device as in claim 18, wherein the first container is fluidly connected to the second container with an outlet second channel.

20. A microreactor device as in claim 19, further comprising a filter between the first container and the second container.

21. A microreactor device as in claim 20, wherein the filter forms a wall of the first container.

22. A microreactor device as in claim 21, wherein the filter is a membrane.

23. A microreactor device as in claim 18, wherein the inlet channel is a microfluidic channel.

24. A microreactor device as in claim 23, wherein the outlet channel is a microfluidic channel.

25. A microreactor device as in claim 17, wherein the second container is a channel forming a loop, the loop channel having movable component present therein.

26. A microreactor device as in claim 25 constructed and arranged such that continuous movement of the agitation component around the loop in one direction moves fluid from the second container into the first container.

27. A microreactor device as in claim 26 constructed and arranged such that movement of fluid from the second container into the first container moves fluid from the first container to the second container.

28. A microreactor device as in claim 27, further comprising a filter that filters fluid as it moves from the first container to the second container.

29. A microreactor device as in claim 25, wherein the movable component is a gas bubble.

30. A microreactor device as in claim 25, wherein the movable component is a liquid immiscible in the fluid of the second container.

31. A microreactor device as in claim 25, wherein the movable component is freely suspendable in the second container within the fluid.

32. A microreactor device as in claim 25, wherein the loop channel is a substantially circular ring.

33. A microreactor device as in claim 17, wherein the second container comprises a sensor for sensing an environmental factor.

34. A method for creating fluid flow in a microreactor device, the microreactor device comprising a biological or biochemical reactor including a reaction site container constructed and arranged to facilitate cell cultivation and having a volume of less than about 2 milliliters, the microreactor device further comprising a second container containing an agitating fluid and a flow generating component in the second container within the agitating fluid, the flow generating component movable in the agitating fluid, the method comprising:
moving the flow generating component in the second container to continuously flow the agitating fluid from the second container into the reaction site container at a substantially uniform flow rate from a first direction for at least five minutes.

35. A method as in claim 34, wherein flowing the agitating fluid from the second container into the reaction site container comprises flowing the agitating fluid through a microfluidic channel that connects the second container to the reaction site container.

36. A method as in claim 34, further comprising continuously flowing an agitating fluid from the second container into the reaction site container at a substantially uniform flow rate from a second direction for at least five minutes and simultaneously with the flow from the first direction.

37. A method as in claim 34, wherein the second container comprises a sensor constructed and arranged to sense an environmental factor in the second container.

38. A method for creating fluid flow in a microreactor device, the microreactor device comprising a first container having a volume of less than about 2 milliliters and comprising a biological or biochemical reactor including a reaction site constructed and arranged to facilitate cell cultivation, the method comprising:
flowing an agitating fluid from a second container into the first container in a repetitive pulsatory manner for at least five minutes.

39. A method as in claim 38, wherein the first container includes two inlets and flowing the agitating fluid in a repetitive pulsatory manner comprises alternating the direction of fluid flow in the reaction site by alternating which of the two inlets provides a greater flow into the first container than the other of the two inlets provides into the first container.

40. A method as in claim 39, wherein when a first of the two inlets introduces the agitating fluid into the first container, the second of the two inlets becomes an outlet for fluid that is contained within the first container.
